(19) United States
(12) Patent Application Publication
(10) Pub. No.: US 2003/0001857 A1
(43) Pub. Date: Jan. 2, 2003

(54) Method and apparatus for determining logical texture coordinate bindings

(76) Inventor: Peter L. Doyle, Dorado Hills, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,982

(22) Filed: Jun. 29, 2001

(51) Int. Cl. G06T 11/40

(52) U.S. Cl. 345/582

(57) ABSTRACT

A computer system and method are provided for mapping of texture images. This may include a memory device to store a plurality of texture coordinates associated with vertices of three dimensional objects and a graphics device coupled to the memory device to process internal texture coordinates. A mapping system may appropriately route select ones of the plurality of texture coordinates from the memory device to the graphics device. The texture images may be mapped onto objects that, when rendered, include the image that may later be displayed on a display device.

### FIELD

The present invention is directed to a computer graphics architecture. More particularly, the present invention is directed to a method and apparatus for determining logical texture coordinate bindings.

### BACKGROUND

A typical computer system includes a processor subsystem of one or more microprocessors such as Intel® i386, i486, Celeron™ or Pentium® processors, a memory subsystem, one or more chipsets provided to support different types of host processors for different platforms such as desktops, personal computers (PC), servers, workstations and mobile platforms, and to provide an interface with a plurality of input/output (I/O) devices including, for example, keyboards, input devices, disk controllers, and serial and parallel ports to printers, scanners and display devices. Chipsets may integrate a large amount of I/O bus interface circuitry and other circuitry onto only a few chips. Examples of such chipsets may include Intel®D 430, 440 and 450 series chipsets, and more recently Intel® 810 and 8XX series chipsets. These chipsets may implement, for example, the I/O bus interface circuitry, direct memory access (DMA) controller, graphics controller, graphics memory controller, and other additional functionality such as graphics visual and texturing enhancements, data buffering, and integrated power management functions.

In traditional three-dimensional (3D) graphics systems, 3D images may be generated for representation on a two-dimensional (2D) display monitor. The 2D representation may be provided by defining a 3D model space and assigning sections of the 3D model space to pixels for a visual display on the display monitor. Each pixel may display the combined visual effects such as color, shade and transparency defined on an image.

The visual characteristics of the 2D representation of the 3D image may also be enhanced by texturing. Texture may represent changes in intensity, color, opacity, or thematic contents (such as surface material type). The process of applying texture patterns to surfaces (adding graphics to scenery) is generally referred to as “texture mapping” and is well known and a widely used technique in computer graphics. The texture may be represented by a 2D array of video data. Data elements in the array are called texels and the array is called a texture map. The two coordinate axes of the texture coordinate space are defined by rows and columns of the array typically designated in “U” and “V” coordinates.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 illustrates a block diagram of an example computer system having a graphics platform according to an example embodiment of the present invention;

FIG. 2 illustrates a block diagram of an example computer system having a host chipset for providing a graphics platform according to an example embodiment of the present invention;

FIG. 3 illustrates a functional diagram of an example graphics and memory controller hub (GMCH) according to an example embodiment of the present invention;

FIG. 4 illustrates an array of data;

FIG. 5 illustrates an example embodiment of the present invention;

FIG. 6 illustrates an example embodiment of the present invention; and

FIG. 7 illustrates example mappings according to an example embodiment of the present invention.

### DETAILED DESCRIPTION

In the following detailed description, like reference numerals and characters may be used to designate identical, corresponding or similar components in differing figure drawings. Arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the knowledge of one skilled in the art. Where specific details are set forth in order to describe example embodiments of the invention, it should be apparent to one skilled in the art that the invention can be practiced without, or with variation of, these specific details. Finally, it should be apparent that differing combinations of hard-wired circuitry and/or software instructions can be used to implement embodiments (or portions of embodiments) of the present invention. That is, embodiments of the present invention are not limited to any specific combination of hardware and/or software.

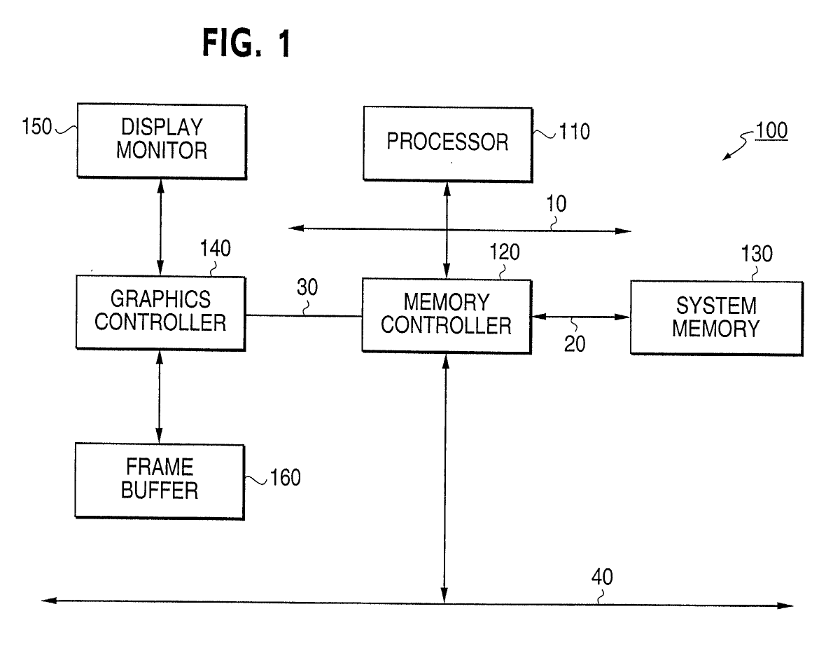

FIG. 1 illustrates an example computer system 100 having a graphics platform according to an example embodiment of the present invention. The computer system 100 (which can be a system commonly referred to as a personal computer or PC) may include one or more processors or processing units 110 such as Intel® i386, i486, Celeron™ or Pentium®) processors, a memory controller 120 coupled to the processing unit 110 via a front side bus 10, a system memory 130 coupled to the memory controller 120 via a memory bus 20, a graphics controller 140 coupled to the memory controller 120 via a graphics bus (e.g., Advanced Graphics Port “AGP” bus) 30.

Alternatively, the graphics controller 140 may also be configured to access the memory controller 120 via a peripheral bus such as a peripheral component interconnect (PCI) bus 40 if so desired. The PCI bus may be a high performance 32 or 64 bit synchronous bus with automatic configurability and multiplexed address, control and data lines as described in the latest version of “PCI Local Bus Specification, Revision 2.1” set forth by the PCI Special Interest Group (SIG) on Jun. 1, 1995 for added-on arrangements (e.g., expansion cards) with new video, networking, or disk memory storage capabilities. The graphics controller 140 may control a visual display of graphics and/or video images on a display monitor 150 (e.g., cathode ray tube, liquid crystal display and flat panel display). The display monitor 150 may be either an interlaced or progressive monitor, but typically is a progressive display device. A frame buffer 160 may be coupled to the graphics controller 140 for buffering the data from the graphics controller 140, the processing unit 110, or other devices within the computer system 100 for a visual display of video images on the display monitor 150.

The memory controller 120 and the graphics controller 140 may be integrated as a single graphics and memory controller hub (GMCH) including dedicated multi-media engines executing in parallel to deliver high performance 3D, 2D and motion compensation video capabilities, for example. The GMCH may be implemented as a PCI chip such as, for example, PIIX4® chip and PIIX6® chip manufactured by Intel Corporation. In addition, such a GMCH may also be implemented as part of a host chipset along with an I/O controller hub (ICH) and a firmware hub (FWH) as described, for example, in Intel@ 810 and 8XX series chipsets.

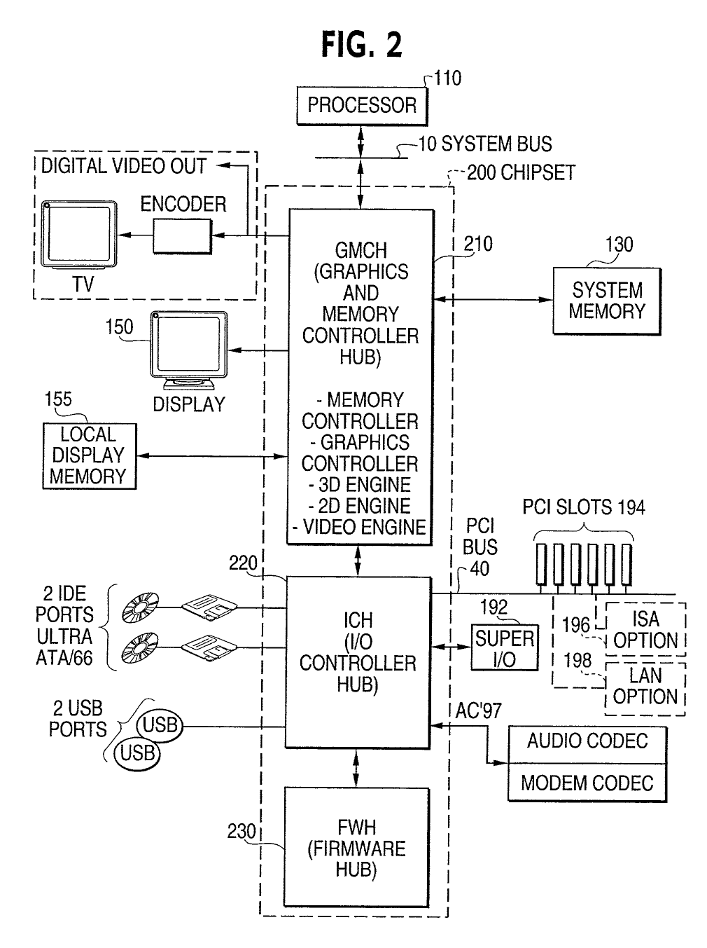

FIG. 2 illustrates an example computer system 100 including such a host chipset 200 according to an embodiment of the present invention. As shown in FIG. 2, the computer system 100 includes essentially the same components shown in FIG. 1, except for the host chipset 200 which provide a highly-integrated three-chip solution consisting of a graphics and memory controller hub (GMCH) 210, an input/output (I/O) controller hub (ICH) 220 and a firmware hub 230 (FWH) 230.

The GMCH 210 may provide graphics and video functions and interfaces one or more memory devices to the system bus 10. The GMCH 210 may include a memory controller as well as a graphics controller (which in turn may include a 3D engine, a 2D engine, and a video engine). The GMCH 210 may be interconnected to any of the system memory 130, a local display memory 155, a display monitor 150 (e.g., a computer monitor) and to a television (TV) via an encoder and a digital video output signal. The GMCH 120 may be, for example, an Intel® 82810 or 82810-DC100 chip. The GMCH 120 may also operate as a bridge or interface for communications or signals sent between the processor 110 and one or more I/O devices which may be connected to the ICH 220.

The ICH 220 may interface one or more I/O devices to the GMCH 210. The FWH 230 may be coupled to the ICH 220 and provide firmware for additional system control. The ICH 220 may be, for example, an Intel® 82801 chip and the FWH 230 may be, for example, an Intel® 82802 chip.

The ICH 220 may be coupled to a variety of I/O devices and the like such as: a Peripheral Component Interconnect (PCI) bus 40 (PCI Local Bus Specification Revision 2.2) which may have one or more I/O devices connected to PCI slots 194, an Industry Standard Architecture (ISA) bus option 196 and a local area network (LAN) option 198; a Super I/O chip 192 for connection to a mouse, keyboard and other peripheral devices (not shown); an audio coder/decoder (Codec) and modem Codec; a plurality of Universal Serial Bus (USB) ports (USB Specification, Revision 1.0); and a plurality of Ultra/66 AT Attachment (ATA) 2 ports (X3T9.2 948D specification; commonly also known as Integrated Drive Electronics (IDE) ports) for receiving one or more magnetic hard disk drives or other I/O devices.

The USB ports and IDE ports may be used to provide an interface to a hard disk drive (HDD) and compact disk read-only-memory (CD-ROM). I/O devices and a flash memory (e.g., EPROM) may also be coupled to the ICH of the host chipset for extensive I/O support and functionality. Those I/O devices may include, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers and scanners. The flash memory may be coupled to the ICH of the host chipset via a low pin count (LDC) bus. The flash memory may store a set of system basic input/output start up (BIOS) routines at startup of the computer system 100. The super I/O chip 192 may provide an interface with another group of I/O devices.

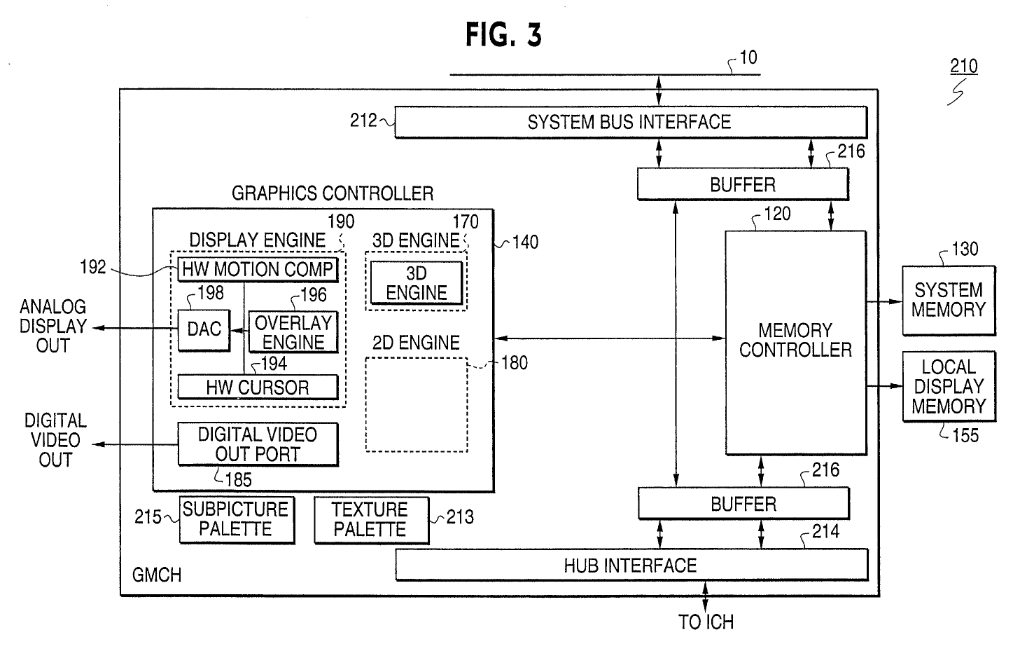

FIG. 3 illustrates a block diagram of a graphics and memory controller hub (GMCH) 210 according to an example embodiment of the present invention. The GMCH 210 may include the graphics controller 140 to provide graphics and video functions and the memory controller 120 to control and interface one or more memory devices via the system bus 20. The memory controller 120 may be coupled to the system bus 40 via a buffer 216 and a system bus interface 212. The memory controller 120 may also be coupled to the ICH 220 via a buffer 216 and a hub interface 214. In addition, the GMCH 210 may be coupled to the system memory 130 and, optionally, a local display memory 155 (also commonly referred to as video or graphics memory typically provided on a video card or video memory card). In a cost saving unified memory architecture (UMA), the local display memory 155 may reside in the computer system. In such an architecture, the system memory 130 may operate as both system memory and the local display memory.

The graphics controller 140 of the GMCH 210 may include a 3D (texture mapping) engine 170 for performing a variety of 3D graphics functions, including creating a rasterized 2D display image from representation of 3D objects, a 2D engine 180 for performing 2D functions, a display engine 190 for displaying video or graphics images, and a digital video output port 185 for outputting digital video signals and providing connection to traditional TVs or new space-saving digital flat panel display.

The 3D (texture mapping) engine 170 may perform a variety of functions including perspective-correct texture mapping to deliver 3D graphics without annoying visual anomalies such as warping, bending or swimming, bilinear and anisotropic filtering to provide smoother and more realistic appearance 3D images, MIP mapping to reduce blockiness and enhance image quality, Gouraud shading, alpha-blending, fogging and Z-buffering.

The display engine 190 may include a hardware motion compensation module 192 for performing motion compensation to improve video quality, a hardware cursor 194 for providing cursor patterns, an overlay engine 196 for merging either video data captured from a video source or data delivered from the 2D engine 180 with graphics data on the display monitor 150, and a digital-to-analog converter (DAC) 198 for converting digital video to analog video signals (YUV color space to RGB color space) for a visual display on the display monitor 150. The hardware motion compensation module 192 may alternatively reside within the 3D engine 170 for purposes of simplicity.

A texture palette 213, also known as a color lookup table (CLUT), may be provided within the GMCH 210 to identify a subset from a larger range of colors. A small number of colors in the palette 213 allows fewer bits to be used to identify the color or intensity of each pixel. The colors for the textures are identified as indices to the texture palette 213. In addition, a subpicture palette 215 may separately be provided for color alpha-blending subpicture pixels for transparency. However, a single dual-purpose palette may be used as both a texture palette and a subpicture palette to save hardware and reduce costs. The alpha-blending of the subpicture with video is an operation typically associated with video processing, while texturing is typically associated with 3D processing.

Embodiments of the present invention will be described with respect to a computer system that includes a memory device to store a plurality of texture coordinates associated with vertices of three dimensional objects, a graphics device to couple to the memory device and to process internal texture coordinates for display, and a mapping system to appropriately route select ones of the plurality of texture coordinates from the memory device to the graphics device.

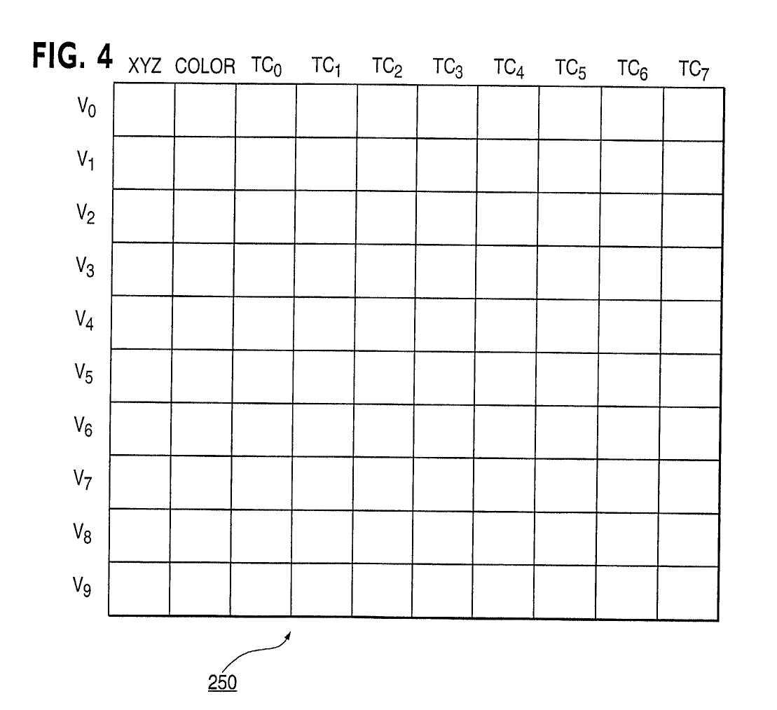

FIG. 4 illustrates a data array 250 that may be provided within the memory (such as the system memory 130). The array 250 may include a large amount of data relating to texture coordinates of the desired image(s). For example, the vertical axis represents the vertices of various triangular coordinates of the image and the horizontal axis represents XYZ data, color data and texture coordinates. For example, a first triangle may include vertices V0, V1 and V2, a second triangle may include vertices V3, V4 and V5, and a third triangle may include vertices V6, V7 and V8. Each of these vertices may be represented by data that may be used by a mapping engine (such as within the 3D engine 170, for example) of the present invention. That is, each of the vertices may correspond to X, Y and Z positional data, color data (such as R, G and B) as well as different texture coordinates. In the array 250 of FIG. 4, eight different texture coordinates are shown, namely texture coordinates TC0, TC1, TC2, TC3, TC4, TC5, TC6 and TC7. Other amounts of texture coordinates as well as other (or different) data may be provided within the array 250.

During texture mapping, select information of the array 250 may be passed from the memory (i.e., the system memory 130) to a graphics device (i.e., the GMCH 140) to appropriately prepare the image. However, it may be disadvantageous to transfer the whole array 250 from the memory to the graphics device as the array 250 may contain an extremely large amount of data and may need to be reformatted at the graphics device. Additionally, hardware (i.e., the graphics device) may only be capable of storing a predetermined number of texture coordinates at one time. For example, the graphics device may only be capable of simultaneously storing data regarding four separate texture coordinates. Disadvantageous arrangements may require the use of software in the transfer of the array 250 to the graphics device. Some of the texture coordinates may be stripped from the array 250 after the array 250 has been transferred to the graphics device. This may involve the software copying the array 250 to an intermediate buffer and then passing select information in the intermediate buffer to the mapping engines. It is therefore desirable for a method and apparatus to transfer only select portions of the array 250 that will be used in the texture engines of the graphics device.

Embodiments of the present invention relate to a graphics device (such as the GMCH 140) supporting multiple texture mappings. A logical binding may be made between internal texture coordinate sets used by the device and externally-stored (i.e., within the system memory) vertex texture coordinates or a default value. The logical mapping may provide substantial flexibility with respect to the use, ordering and replication of vertex texture coordinates. Without this flexibility, the graphics driver may have to generate a second, rearranged copy of the vertex data at the costs of memory footprints, and additional processor overhead, complexity and thus lower system performance.

More specifically, a graphics device may support and use up to four internal texture coordinate sets for texture mapping. These internal coordinate sets may be either bound to one of eight vertex texture coordinate sets or a default value. The graphics device may use different amounts of internal texture coordinates in accordance with embodiments of the present invention.

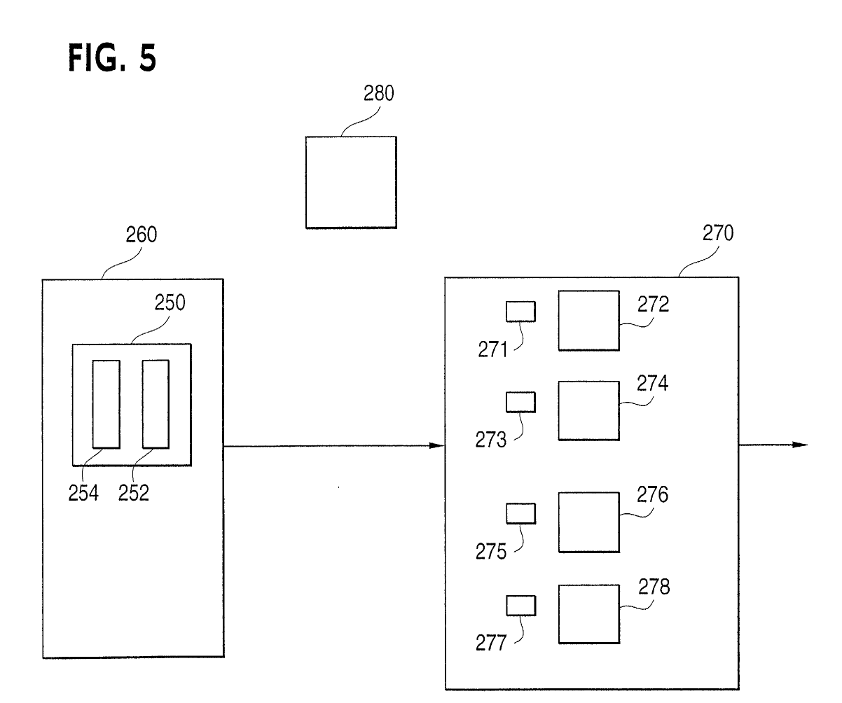

FIG. 5 illustrates texture coordinate data transfer according to an example embodiment of the present invention. Other embodiments and configurations are also within the scope of the present invention. More specifically, FIG. 5 illustrates a memory 260 (such as the system memory 130 of FIG. 3), a graphics device 270 (such as the GMCH 140 of FIG. 3) and software 280 that controls, among other things, the transfer of texture coordinates from the memory 260 to the graphics driver 270. The software 280 may reside in external memory. The memory 260 is shown as including the array 250. For illustration purposes, the array 250 may include texture coordinate data 252 and non-texture coordinate data 254. As show in FIG. 5, the graphics device 270 may include four texture mapping engines, namely a texture mapping engine (TME0) 272, a texture mapping engine (TME1) 274, a texture mapping engine (TME2) 276, and a texture mapping engine (TME3) 278. While this embodiment only illustrates four texture mapping engines within the graphics device 270, other numbers of texture mapping engines are also within the scope of the present invention.

The graphics device 270 may further include a register 271 associated with the texture mapping engine 272, a register 271 associated with the texture mapping engine 274, a register 275 associated with the texture mapping engine 276 and a register 277 associated with the texture mapping engine 278. Each of the registers 271, 273, 275 and 277 may be used to select the appropriate texture coordinate values to be obtained from the memory 260 (or a default value) for each of the texture mapping engine 272, the texture mapping engine 274, the texture mapping engine 276 and the texture mapping engine 278, respectively. During operation, the software 280 may set values within the respective registers 271, 273, 275 and 277 such that the texture mapping engines 272, 274, 276 and 278 receive the appropriate texture coordinates from the memory 260. In accordance with embodiments of the present invention, the entire array 250 of texture coordinates does not needed to be transferred from the memory 260 to the graphics device 270. That is, embodiments of the present invention route the proper texture coordinates to the appropriate texture mapping engines and avoid transferring unneeded texture coordinates from the array 250. The software 280 may appropriately pick the texture coordinates to be transferred to the texture mapping engines 272, 274, 276 and 278. This avoids the graphics device 270 from having to reformat the vertex texture buffers after they have been transferred from the memory 260 to the graphics device 270.

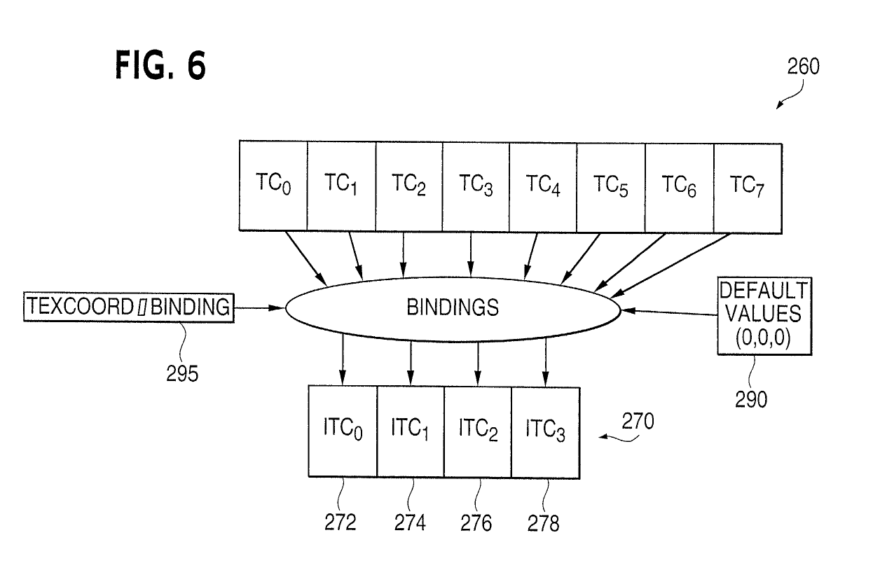

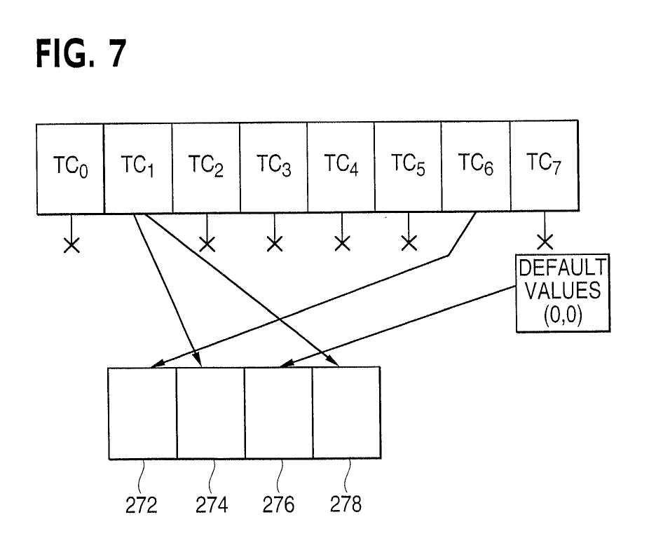

FIGS. 6 and 7 illustrate how embodiments of the present invention may be useful to appropriately route the texture coordinate data from the memory 260 to the graphics device 270. As shown in FIG. 6, the memory 260 (of FIG. 5) may include eight vertex texture coordinates TC0, TC1, TC2, TC3, TC4, TC5, TC6 and TC7. These texture coordinates may be provided within the array 250 or may be provided within vertex texture buffers. The graphics device 270 (of FIG. 5) is represented in FIG. 6 as four internal texture coordinates (ITC0, ITC1, ITC2 and ITC3) that will be provided within the four texture mapping engines 272, 274, 276 and 278, respectively. In accordance with embodiments of the present invention, the four internal texture coordinates (ITC0, ITC1, ITC2 and ITC3) to be provided to the four texture mapping engines 272, 274, 276 and 278 (at the graphics device 270) may be default values 290 (such as 0,0,0) or may be one of the texture coordinates TC0, TC1, TC2, TC3, TC4, TC5, TC6 and TC7 provided within the memory 260. The selection as to which texture coordinates will be provided as the internal texture coordinates ITC0, ITC1, ITC2 and ITC3 (corresponding to the mapping engines 272, 274, 276 and 278) may be based on a signal TexCoord [symbol] binding 295. This signal may be provided by the software 280 to appropriately route the appropriate texture coordinates to the texture mapping engines 272, 274, 276 and 278. That is, the software 280 may specify, in this example, that the internal texture coordinates may come from any one of the texture coordinates TC0, TC1, TC2, TC3, TC4, TC5, TC6 and TC7 or from the default value. In other words, the software 280 may select the source of the texture coordinates for each texture mapping engine 272, 274, 276 and 278. The software 280 may make this selection based on the desired image to be created and the desire to avoid unneedlessly transferring data from the memory 260 to the graphics device 270. The apparatus appropriately routes (or transfers) the selected texture coordinates to the proper texture mapping engines 272, 274, 276 and 278 (as the internal texture coordinates ITC0, ITC1, ITC2 and ITC3) by utilizing the registers 271, 273, 275 and 277. Accordingly, the graphics device 270 may only obtain a limited number of texture coordinates from the memory 260 and avoid obtaining the unnecessary texture coordinates for a particular image. This additionally avoids the software 280 from having to reformat the array 250 when it arrives at the graphics device 270 as in disadvantageous arrangements.

FIG. 6 further shows that the TexCoord [symbol] Binding state variable may specify the data source for each internal coordinate set. Other ways of setting each internal coordinate set are also within the scope of the present invention.

In at least one embodiment, each of registers 271, 273, 275 and 277 may separately store a multi-bit value (i.e., four bits) indicating a location as to where to obtain texture coordinates. For example, bit values of 0-7 may represent the texture coordinates 0-7, respectively, and a bit value of 8 may represent a default value.

FIG. 7 shows an example mapping (or transferring) in accordance with an embodiment of the present invention. Other mappings are also within the scope of the present invention. More specifically, FIG. 7 shows that the texture coordinate TC6 is mapped to the texture mapping engine 272, the texture coordinate TC1 is mapped to both the texture mapping engine 274 and the texture mapping engine 278 and a default value (0, 0) is mapped to the texture mapping engine 276. Stated differently, the internal texture coordinate ITC0 is bound to the texture coordinate TC6, the internal texture coordinate ITC2 receives a default value (0,0), and the internal texture coordinate ITC1 and the internal texture coordinate ITC3 are both bound to the texture coordinate TC1. This “cloning” of a vertex texture coordinate set (e.g., texture coordinate TC1) is particularly useful when a single vertex texture coordinate set is bound to two different texture mappings, though with different address (wrap) control or texture coordinate transformaton matrices etc. In this example, the texture coordinates TC0,TC2, TC3, TC4, TC5 and TC7 are not used and are effectively ignored by the graphics device (although they are present in the vertex data array).

Accordingly, by utilizing these logical bindings, specific vertex texture coordinate sets that are present in the vertex data array may be ignored. This may better support the operation of the Direct 3D API, which does not prevent unused texture coordinate sets from being presented to the graphics driver or stored in the vertex buffers. This allows applications to keep one vertex database (with possibly more texture coordinates sets than the hardware can use at any point in time) and then employ a multipass rendering algorithm where a subset of the coordinate sets may be used in each pass.

The logical binding functionality may allow multiple internal texture coordinate sets to be bound to the same vertex texture coordinate sets. This may be useful for replicating vertex texture coordinate sets in order to apply different attributes (e.g., texture address controls, texture coordinate transforms, etc.) to the same texture coordinate set for use with different texture mappings. This may be useful for matching the Direct 3D API semantics of associating these controls with texture stages versus texture coordinate sets.

The logical bindings also allow the vertex texture coordinate sets to be used in a random (versus strictly sequential) fashion.

Embodiments of the present invention provide advantages over graphic devices that support a fixed (i.e., implied) binding between the vertex texture coordinate set and the internal texture coordinate sets. That is, embodiments of the present invention permit vertex texture coordinates to be ignored, permit vertex texture coordinates to be replicated, permit vertex texture coordinates to be used in random order and permit the association of a default value to a texture coordinate set. Without this flexibility, the graphics driver would be generate a second, rearranged copy of the vertex data, which adds additional memory bandwidth requirements and software overhead and thus reduces the system performance.

By utilizing embodiments of the present invention, an image may be generated by a graphics device by rendering the objects and using the texture coordinates to assign the appropriate texture map contents to the pixels of the objects. The image may be later displayed on a display device.

Embodiments of the present invention may relate to a computer system that includes a memory device to store a plurality of texture coordinates associated with vertices of three dimensional objects, a graphics device having a plurality of mapping engines each to be used to map at least one of the objects based on a plurality of internal texture coordinates, and a mapping system to transfer select ones of the plurality of texture coordinates in the memory device to the mapping engines without transferring unselected one of the plurality of texture coordinates from the memory device to the mapping engines.

Any reference in this description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments.

Further, embodiments of the present invention or portions of embodiments may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc.

A machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other forms of propagated signals (e.g., carrier waves, infrared signals, digital signals, etc.); etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A computer system comprising:
a memory device to store a plurality of texture coordinates associated with vertices of three dimensional objects;
a graphics device to couple to said memory device and to process internal texture coordinates for display; and
a mapping system to appropriately route select ones of said plurality of texture coordinates from said memory device to said graphics device.

2. The computer system of claim 1, further comprising a display device to display an image based on an output of said graphics device.

3. The computer system of claim 1, wherein said graphics device comprises a plurality of mapping engines each to process a separate one of said internal texture coordinates.

4. The computer system of claim 3, wherein said graphics device further comprises a plurality of registers, each corresponding to a separate one of said plurality of mapping engines.

5. The computer system of claim 4, wherein a value within each of said registers corresponds to a source of the texture coordinate for said corresponding mapping engine.

6. The computer system of claim 5, wherein said source comprises one of: a default and one of said plurality of said texture coordinates in said memory device.

7. The computer system of claim 4, wherein said mapping system assigns a value into each register to select the appropriate texture coordinate.

8. A computer system comprising:
a memory device to store a plurality of texture coordinates associated with vertices of three dimensional objects;
a graphics device having a plurality of mapping engines each to map at least one of said objects based on a plurality of internal texture coordinates; and
a mapping system to transfer select ones of said plurality of texture coordinates in said memory device to said mapping engines without transferring unselected ones of said plurality of texture coordinates from said memory device to said graphics device.

9. The computer system of claim 8, further comprising a display device to display an image based on an output of said graphics device.

10. The computer system of claim 8, wherein said graphics device further includes a plurality of registers, each corresponding to a separate one of said plurality of mapping engines.

11. The computer system of claim 10, wherein said mapping system assigns a value to each register so as to select a source of the internal texture coordinates for each of said mapping engines.

12. The computer system of claim 11, wherein said source comprises one of: a default and one of said plurality of said texture coordinates in said memory device.

13. A graphics device for creating an image based on internal texture coordinates received from a memory device, said graphics device including a plurality of mapping engines and a plurality of registers, each register corresponding to a source of texture coordinate values for one of said mapping engines.

14. The graphics device of claim 13, further comprising a display device to display said image based on an output of said graphics device.

15. The graphics device of claim 13, wherein said source comprises one of: a default and one of a plurality of said texture coordinates stored in said memory device.

16. The graphics device of claim 13, wherein a mapping system appropriately selects the texture coordinates for routing to each of the mapping engines.

17. A method comprising:
receiving a plurality of texture coordinate values in a memory device, said plurality of texture coordinates being associated with vertices of three dimensional objects;
selecting ones of said plurality of texture coordinate values for mapping of at least one of said objects; and
transferring said select ones of said plurality of texture coordinates values from said memory device to mapping engines.

18. The method of claim 17, wherein said select ones of said plurality of texture coordinates are transferred from said memory device to said mapping engines without transferring unselected ones of said plurality of texture coordinates.

19. The method of claim 17, wherein said selecting comprises associating a source of texture coordinates for each of said mapping engines.

20. The method of claim 19, wherein said associating comprises, for each mapping engine, setting a value of a register corresponding to said each mapping engine.

21. The method of claim 20, wherein said value corresponds to one of: a default value and one of said plurality of texture coordinates values.

22. A program storage device readable by machine, tangibly embodying a program of instructions executable by the machine to perform a method comprising:
selecting ones of a plurality of texture coordinate values in a memory device, said plurality of texture coordinates values being associated with vertices of three dimensional objects; and
transferring said select ones of said plurality of texture coordinates values from said memory device to mapping engines.

23. The program storage device of claim 22, wherein said select ones of said plurality of texture coordinates are transferred from said memory device to said mapping engines without transferring unselected ones of said plurality of texture coordinate values.

24. The program storage device of claim 22, wherein said selecting comprises associating a source of texture coordinates for each of said mapping engines.
